(19) United States
(12) Patent Application Publication
(10) Pub. No.: US 2024/0332576 A1
(43) Pub. Date: Oct. 3, 2024

(54) POWER SOURCE

(71) Applicant: TOYOTA JIDOSHA KABUSHIKI KAISHA, Toyota-cho (JP)

(72) Inventors: Makito OKUMURA, Nagoya-shi (JP); Mikio Yasunaga, Miyoshi-shi (JP); Kenji SATO, Kasugai-shi (JP)

(73) Assignee: TOYOTA JIDOSHA KABUSHIKI KAISHA, Toyota-shi (JP)

(21) Appl. No.: 18/416,951

(22) Filed: Jan. 19, 2024

(30) Foreign Application Priority Data
Mar. 27, 2023 (JP) 2023-049820

(51) Int. Cl. H01M 8/04858; H01M 8/04029

(52) U.S. Cl. CPC H01M 8/0491; H01M 8/04029

(57) ABSTRACT

It is a power source in which a plurality of fuel cell systems and one boost converter are connected in series and output power according to the required power. Among the plurality of fuel cell systems, the first fuel cell system generates electricity using a power command obtained by dividing the required power by the number of the plurality of fuel cell systems, and the other fuel cell systems except the first fuel cell system Electricity is generated using a current command having the same current value as the output current of the first fuel cell system.

### CROSS-REFERENCE TO RELATED APPLICATION

This application claims priority to Japanese Patent Application No. 2023-049820 filed on Mar. 27, 2023, incorporated herein by reference in its entirety.

### BACKGROUND

### 1. Technical Field

The present disclosure relates to a power source.

### 2. Description of Related Art

Disclosures related to fuel cell electric vehicles including a plurality of fuel cell power systems have hitherto been known. For example, in a fuel cell electric vehicle described in Japanese Unexamined Patent Application Publication No. 2022-155083 (JP 2022-155083 A), a driving power source includes a plurality of fuel cell systems each having a fuel cell stack and a fuel tank that stores a fuel gas and supplies the fuel gas to the fuel cell stack, and is electrically switchably connected to the output of any one of the fuel cell systems.

### SUMMARY

A high-output power source is required for fuel cell electric vehicles that perform high-load travel such as towing and uphill towing, for example. However, the output of the power source cannot be improved by simply electrically switching to the output of any one of the fuel cell systems, as in the driving power source described in JP 2022-155083 A. Furthermore, if each of the fuel cell systems is provided with a boost converter, not only the cost and the installation space are increased, but also a power loss is caused by individual boost converters. Thus, the inventors of the present application have considered connecting a plurality of fuel cell systems and one boost converter in series to make the boost converter common to the fuel cell systems.

However, when fuel cell systems are connected in series to make a boost converter common to the fuel cell systems, the same current flows through the fuel cell systems, but actuators of hydrogen gas supply systems, air supply systems, and coolant supply systems of the fuel cell systems operate differently for the same current. Therefore, if each of the fuel cell systems connected in series is made to generate power according to a power command, the actuators cannot operate as intended, which makes it difficult to stably output power that matches required power.

The present disclosure provides a power source in which a plurality of fuel cell systems and one boost converter are connected in series and which can output stable power according to required power.

An aspect of the present disclosure provides a power source in which a plurality of fuel cell systems and one boost converter are connected in series to output power that matches required power, in which a first fuel cell system, among the fuel cell systems, generates power using a power command obtained by dividing the required power by a number of the fuel cell systems, and other fuel cell systems excluding the first fuel cell system generate power using a current command having the same current value as an output current of the first fuel cell system.

In the power source, each of the fuel cell systems may include an independent air supply system.

In the power source, each of the fuel cell systems may include an independent coolant supply system.

According to the above aspect of the present disclosure, it is possible to provide a power source in which a plurality of fuel cell systems and one boost converter are connected in series and which can output stable power according to required power.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing Embodiment 1 of a power source according to the present disclosure;

FIG. 2 is a flow diagram showing the process flow of the power source in FIG. 1;

FIG. 3 is a schematic configuration diagram showing Embodiment 2 of the power source of the present disclosure; and

FIG. 4 is a schematic configuration diagram showing Embodiment 3 of the power source of the present disclosure.

### DETAILED DESCRIPTION OF EMBODIMENTS

Hereinafter, embodiments of a power source according to the present disclosure will be described with reference to the drawings.

### Embodiment 1

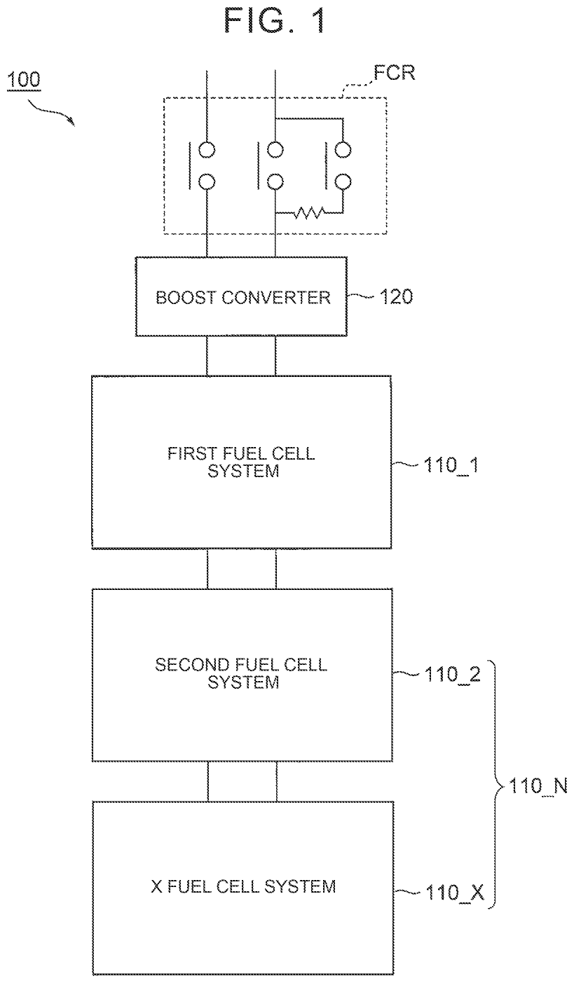

FIG. 1 is a schematic configuration diagram showing a first embodiment of a power source according to the present disclosure. The power source 100 of this embodiment is, for example, a vehicle drive power source that is mounted on a vehicle such as a fuel cell electric vehicle and drives an electric motor for driving. The power source 100 of this embodiment includes, for example, a plurality of fuel cell systems 110 electrically connected in series, and one boost converter 120 electrically connected in series with the plurality of fuel cell systems 110, and outputs power according to the required power.

The power source 100 is connected to, for example, an electric motor inverter (not shown) or a vehicle battery converter via a relay FCR. Further, the power source 100 includes, for example, a control device (not shown). The control device is configured by, for example, an electronic control unit (ECU), and the central processing unit (CPU) executes a program stored in memory to control the plurality of fuel cell systems 110, boost converter 120, and relay FCR. Control.

The plurality of fuel cell systems 110 include, for example, one first fuel cell system 110_1 and one or more other fuel cell systems 110_N. The other fuel cell system 110_N includes, for example, N fuel cell systems 110 (N is any natural number). That is, the other fuel cell system 110_N is, for example, one second fuel cell system 110_2, or the X-th (X is a natural number of 3 or more) fuel cell system 110_X from the second fuel cell system 110_2. A plurality of fuel cell systems 110 are included.

Each fuel cell system 110 includes, for example, a fuel cell stack (not shown), a hydrogen gas supply system, an air supply system, and a coolant supply system. A fuel cell stack has, for example, a structure in which a plurality of single cells of solid oxide fuel cell are stacked. The hydrogen gas supply system includes, for example, a high-pressure hydrogen tank, a pressure reducing valve, a hydrogen injector, an actuator, a hydrogen pump, a flow sensor, a pressure sensor, and an exhaust and drain valve. The air supply system includes, for example, an air cleaner, an air compressor, an intercooler, a flow divider valve, a sealing valve, a pressure regulating valve, an actuator, a flow sensor, a pressure sensor, and a muffler. The coolant supply system includes, for example, a radiator, a three-way valve, an ion exchanger, a water pump, a flow rate sensor, and a pressure sensor.

The control device of the power source 100 obtains detected values of the flow rate and pressure of hydrogen gas from, for example, a flow rate sensor and a pressure sensor of the hydrogen supply system, controls a hydrogen pump or an actuator, and supplies hydrogen gas to each fuel cell system 110. Control the flow rate and pressure of hydrogen gas. Further, the control device of the power source 100 acquires detected values of air flow rate and pressure from a flow rate sensor and a pressure sensor of the air supply system, controls an air compressor and an actuator, and supplies the air to each fuel cell system 110. control the flow rate and pressure of air. Further, the control device of the power source 100 obtains detected values of the flow rate and pressure of the coolant supply system, and controls the water pump and actuator to supply each fuel cell system 110 with the detected values. Controls the flow rate and pressure of the coolant supplied.

Boost converter 120 is disposed, for example, between relay FCR and multiple fuel cell systems 110, and is electrically connected to relay FCR and multiple fuel cell systems 110 in series. Boost converter 120 boosts the output voltage of a plurality of series-connected fuel cell systems 110, for example. Further, the boost converter 120 outputs a current corresponding to the output current of the first fuel cell system 110_1, which generates electricity based on the power command.

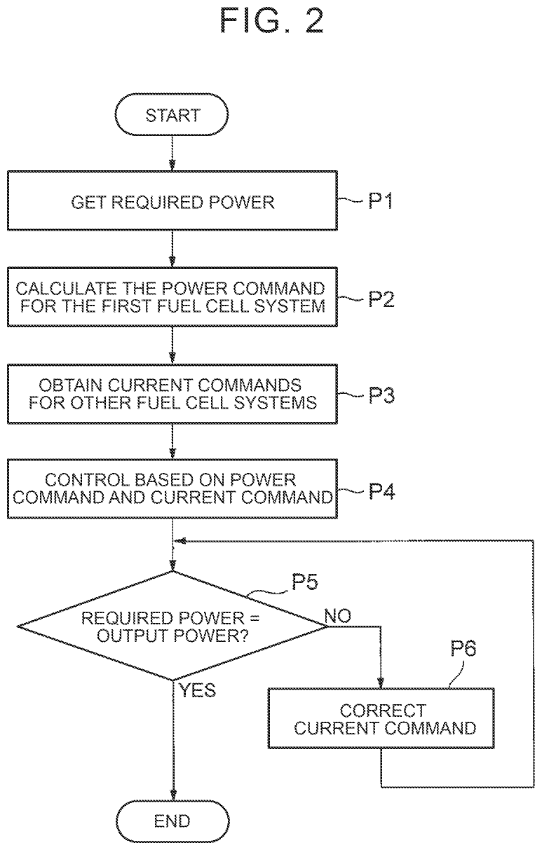

FIG. 2 is a flow diagram showing the processing flow of the power source 100 of FIG. 1. For example, when the power source 100 starts the process flow shown in FIG. 2, it executes a process P1 to obtain the required power. In this process P1, the control device of the power source 100 obtains, for example, the required power P required by the electric motor for driving and other on-vehicle devices from another ECU mounted on the vehicle. After that, the power source 100 executes the next process P2.

In process P2, the power source 100 calculates, for example, a power command PC for the first fuel cell system 110_1. More specifically, for example, the control device of the power source 100 calculates the required power P obtained in the previous process P1 by the number M (M is a natural number of 2 or more) of the plurality of fuel cell systems 110 connected in series. The divided power value P/M is calculated as the power command PC of the first fuel cell system 110_1. After that, the power source 100 executes the next process P3.

In process P3, the power source 100 obtains, for example, a current command for each of the other fuel cell systems 110_N except the first fuel cell system 110_1. More specifically, for example, the control device of the power source 100 changes the output current of the first fuel cell system 110_1 when the first fuel cell system 110_1 generates electricity using the power command PC to the output current of the other fuel cell system 110_N. Acquired as a current command IC for each. Note that the output current when the first fuel cell system 110_1 generates power according to the power command PC may be recorded in advance in a memory, or may be detected by a current sensor.

After that, the power source 100 executes a process P4 for controlling the plurality of fuel cell systems 110 based on the power command PC and the current command IC. In this process P4, the control device of the power source 100 controls the first fuel cell system 110_1 based on the power command PC, and controls the other fuel cell system 110_N based on the current command IC, for example.

More specifically, the control device of the power source 100 controls the hydrogen gas supply system, the air supply system, and the coolant supply system of the first fuel cell system 110_1 so that the first fuel cell system 110_1 generates power equal to the power command PC, for example. Further, the control device of the power source 100 controls the hydrogen gas supply system, air supply system, and coolant supply system of the other fuel cell system 110_N so that the output current of the other fuel cell system 110_N becomes equal to the current command IC. control the system.

After that, the power source 100 executes a process P5 of determining whether the required power P is equal to the output power OP of the power source 100. In this process P5, the control device of the power source 100 calculates the output power OP of the power source 100 based on the voltage value and current value acquired from the voltage sensor and the current sensor, and compares it with the required power P acquired in the process P1. do. In this process P5, when the power source 100 determines that the required power P and the output power OP are equal (YES), it ends the process flow shown in FIG. 2 and determines that the required power P and the output power OP are different. If the determination is NO, the next process P6 is executed.

In process P6, the power source 100 corrects the current command IC. More specifically, for example, the control device of power source 100 corrects the value of current command IC so that required power P and output power OP match. More specifically, the control device of the power source 100 performs feedback control on the first fuel cell system 110_1 based on the difference between the required power P and the output power OP, so that the control device controls the other fuel cell systems 110_N. Correct the current command IC.

That is, when the output power OP is smaller than the required power P, the control device increases the power command PC of the first fuel cell system 110_1, and when the output power OP is larger than the required power P, the control device decreases the power command PC of the first fuel cell system 110_1. Further, the control device controls the other fuel cell systems 110_N using the same current value as the output current of the first fuel cell system 110_1 that generates the increased or decreased new power command PC as the corrected current command IC.

In this way, feedback of the difference between the required power P and the output power OP is performed only in the first fuel cell system 110_1, and the other fuel cell systems 110_N are controlled by the current command IC, thereby controlling the feedback in the power source 100. Sexuality becomes stable. Thereafter, the power source 100 repeats the process P5 and the process P6 until it is determined in the process P5 that the required power P and the output power OP are equal (YES).

Hereinafter, the operation of the power source 100 of this embodiment will be explained based on comparison with a conventional drive power source.

For example, a fuel cell electric vehicle that performs high-load driving such as towing or towing uphill requires a high-output power source. However, as in the drive power source described in the above-mentioned JP 2022-155083 A, it is not possible to improve the output of the power source by simply electrically switching to the output of one of the plurality of fuel cell systems. I can't. Furthermore, if each fuel cell system is equipped with a boost converter, not only will cost and installation space increase, but each boost converter will generate power loss.

On the other hand, when a plurality of fuel cell systems 110 are connected in series and the boost converter 120 is shared, the same current flows through each fuel cell system 110. However, the actuators of the hydrogen gas supply system, air supply system, or coolant supply system of each fuel cell system 110 that output the same current during power generation operate differently. Therefore, if each of the plurality of fuel cell systems 110 connected in series is caused to generate electricity using the power command PC, the actuator will not be able to operate as intended, and it will be difficult to stably output power according to the required power P. Have difficulty.

On the other hand, the power source 100 of this embodiment has a plurality of fuel cell systems 110 and one boost converter 120 connected in series and outputs electric power according to the required power P. Among these plurality of fuel cell systems 110, the first fuel cell system 110_1 generates electricity using a power command PC obtained by dividing the required power P by the number M of the fuel cell systems 110 connected in series, and the other fuel cell systems 110_N other than the first fuel cell system 110_1 generate electricity with a current command IC having the same current value as the output current of the first fuel cell system 110_1.

With such a configuration, according to the power source 100 of the present embodiment, the boost converter 120 can be shared among the plurality of fuel cell systems 110 connected in series, reducing cost and installation space, and Power loss can be reduced. Further, the operating point of the actuator of the first fuel cell system 110_1 and the operating point of the actuator of the other fuel cell system 110_N can be made equal to realize the desired operation, and the power source 100 can provide the required power P It becomes possible to stably output power according to the amount of power.

That is, among the plurality of fuel cell systems 110, each of the fuel cell systems 110_N other than the first fuel cell system 110_1 has a different actuator operation for outputting the same current during power generation. Therefore, by controlling each of the other fuel cell systems 110_N with the current command IC, it becomes possible to individually control each actuator of the other fuel cell system 110_N with each of the other fuel cell systems 110_N. This stabilizes the output of the other fuel cell system 110_N connected in series to the first fuel cell system 110_1, and allows the power source 100 to stably output power according to the required power P.

Furthermore, a current larger or smaller than the current output by each fuel cell system 110 when generating power is prevented from flowing into each fuel cell system 110. This not only allows each fuel cell system 110 to generate power more efficiently, but also suppresses deterioration of the solid electrolyte, air electrode, fuel electrode, etc. that constitute the single cell of the fuel cell stack.

As described above, according to the present embodiment, a plurality of fuel cell systems 110 and one boost converter 120 are connected in series to provide a power source 100 that can output stable power according to the required power P.

### Embodiment 2

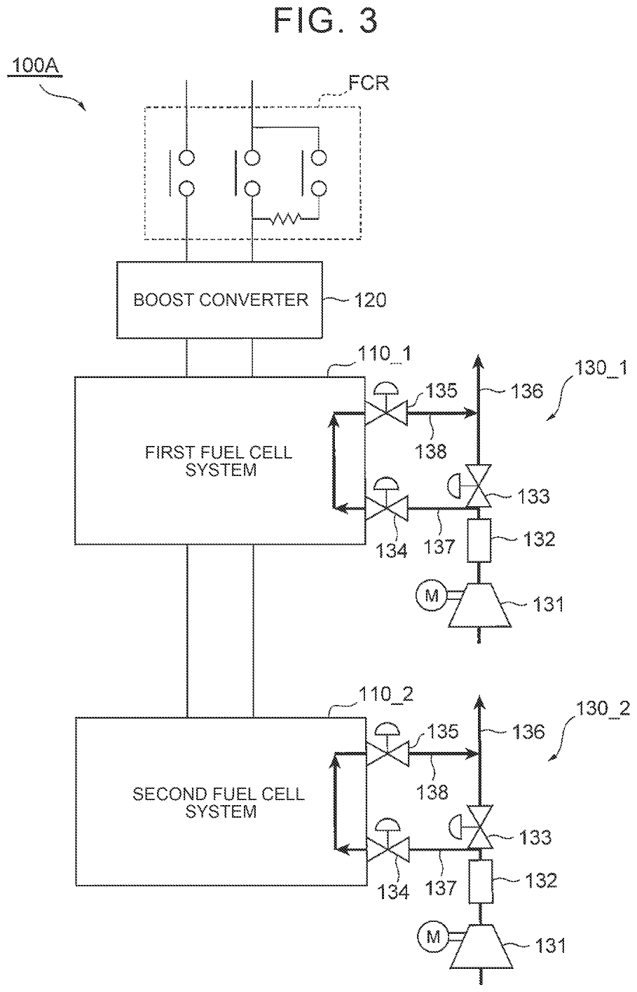

FIG. 3 is a schematic configuration diagram showing a second embodiment of a power source according to the present disclosure. The power source 100A of this embodiment differs from the power source 100 of the first embodiment described above in that each of the plurality of fuel cell systems 110 includes an independent air supply system 130. The other configuration of the power source 100A of this embodiment is the same as that of the power source 100 of the above-described first embodiment, so the same parts are given the same reference numerals and the explanation will be omitted.

As shown in FIG. 3, the first air supply system 130_1 that supplies air to the first fuel cell system 110_1 and the second air supply system 130_2 that supplies air to the second fuel cell system 110_2 are the same. It has the following configuration and is provided independently. Each air supply system 130 includes, for example, an air compressor 131, an intercooler 132, a flow dividing valve 133, a sealing valve 134, a pressure regulating valve 135, an air supply/discharge path 136, an air introduction path 137, and an air discharge path 138.

The air compressor 131 is provided, for example, on the upstream side of the air supply/discharge path 136, is controlled by the control device of the power source 100A, and pumps air at a predetermined flow rate or pressure. Intercooler 132 is provided, for example, in air supply/discharge path 136 downstream of air compressor 131, and cools the air compressed by air compressor 131 by heat exchange with coolant.

The flow dividing valve 133 is, for example, a control valve provided in air supply/discharge path 136 downstream of intercooler 132, and is controlled by the control device of power source 100A to open/close air supply/discharge path 136. The sealing valve 134 is, for example, a control valve provided at the inlet of the air manifold of each of the plurality of fuel cell systems 110, and is controlled by the control device of the power source 100A to open and close the inlet of the air manifold.

The pressure regulating valve 135 is, for example, a control valve provided at the outlet of the air manifold of each of the plurality of fuel cell systems 110, and its opening degree is controlled by the control device of the power source 100A. Adjust the pressure of the air flowing through the passage of each of the fuel cell systems 110. The air supply/discharge path 136, for example, branches from an air supply path provided with an air cleaner and merges with an exhaust path provided with a muffler.

For example, the air introduction path 137 branches from the air supply/discharge path 136 between the intercooler 132 and the flow dividing valve 133 and is connected to the air inlet of the sealing valve 134. For example, the air discharge path 138 has an upstream end connected to the air outlet of the pressure regulating valve 135, and a downstream end connected to the air supply/discharge path 136 downstream of the flow dividing valve 133.

With such a configuration, the control device of the power source 100A individually controls each air supply system 130 independently provided in each fuel cell system 110, and adjusts the amount of air supplied to each fuel cell system 110. can be controlled individually. As a result, the power source 100A of this embodiment has the same effects as the power source 100 of the first embodiment described above, and also has functions such as controlling the amount of heat generated to warm up each fuel cell system 110 and preventing deterioration of the single cell. This has the advantage of being able to perform voltage control for.

### Embodiment 3

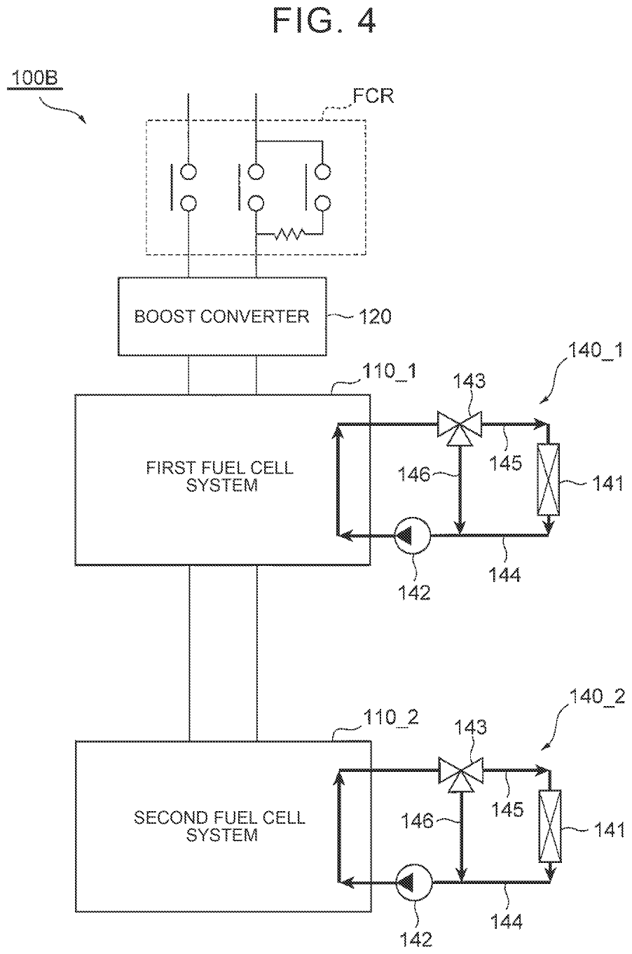

FIG. 4 is a schematic configuration diagram showing a third embodiment of a power source according to the present disclosure. The power source 100B of this embodiment differs from the power source 100 of the above-described first embodiment in that each of the plurality of fuel cell systems 110 includes an independent coolant supply system 140. The other configuration of the power source 100B of this embodiment is the same as that of the power source 100 of the above-described first embodiment, so the same parts are given the same reference numerals and the explanation will be omitted.

As shown in FIG. 4, a first coolant supply system 140_1 supplies coolant to the first fuel cell system 110_1, and a second cooling water supply system supplies coolant to the second fuel cell system 110_2. 140_2 has the same configuration and is provided independently. Each coolant supply system 140 includes, for example, a radiator 141, a water pump 142, a three-way valve 143, a coolant supply path 144, a coolant return path 145, and a bypass path 146.

The radiator 141 cools the coolant, for example, by exchanging heat with the outside air. The water pump 142 is provided, for example, in a coolant supply path 144 that connects the coolant inlet of the fuel cell system 110 and the coolant outlet of the radiator 141, is controlled by the control device of the power source 100B, and is cooled by the radiator 141. The coolant is pumped to the coolant inlet of the fuel cell system 110 at a predetermined flow rate or pressure.

The three-way valve 143 is, for example, a branch point of a bypass path 146 that branches off from a coolant return path 145 that connects the cooling water outlet of the fuel cell system 110 and the coolant inlet of the radiator 141 and is connected to the coolant supply path 144. It is set in. In the three-way valve 143, opening and closing of the coolant return path 145 and the bypass path 146 are controlled by the control device of the power source 100B. As a result, the control device selects a cooling mode in which the coolant discharged from the coolant outlet of the fuel cell system 110 is returned to the coolant inlet of the radiator 141, and a cooling mode in which the coolant is returned to the cooling water inlet of the fuel cell system 110 via the bypass path 146. Switch between circulation mode and circulation mode.

With such a configuration, the power source 100B of this embodiment controls the temperature and flow rate of coolant supplied to each fuel cell system 110 according to the temperature of each fuel cell system 110 having a different calorific value. be able to. Thereby, the power generation efficiency of each fuel cell system 110 can be improved. Furthermore, the service life of each fuel cell system 110 can be extended. Note that each coolant supply system 140 may be provided with a radiator 141, but a common radiator 141 may be used for a plurality of coolant supply systems 140.

Although the embodiment of the power source according to the present disclosure has been described above in detail using the drawings, the specific configuration is not limited to this embodiment, and design changes etc. may be made without departing from the gist of the present disclosure. Even if there are, they are included in this disclosure.

What is claimed is:

1. A power source in which a plurality of fuel cell systems and one boost converter are connected in series and which outputs power that matches required power, wherein a first fuel cell system, among the fuel cell systems, generates power using a power command obtained by dividing the required power by a number of the fuel cell systems, and other fuel cell systems excluding the first fuel cell system generate power using a current command having the same current value as an output current of the first fuel cell system.

2. The power source according to claim 1, wherein each of the fuel cell systems includes an independent air supply system.

3. The power source according to claim 1, wherein each of the fuel cell systems includes an independent coolant supply system.
